(19) United States
(12) Patent Application Publication
(10) Pub. No.: US 2008/0006640 A1
(43) Pub. Date: Jan. 10, 2008

(54) Mop bucket and method

(76) Inventor: Joseph A. Natale, Brooklyn, NY (US)

Correspondence Address: Steven Horowitz;Counselor At Law, Suite 700, 295 Madison Avenue, New York, NY, 10017, US

(21) Appl. No.: 11/483,116

(22) Filed: Jul. 7, 2006

(51) Int. Cl. B08B 7/00

(52) U.S. Cl. 220/507; 134/6; 15/264

(57) ABSTRACT

A mop bucket that saves, water, cleaning liquid, time and effort includes a bottom, an outer wall inclined to facilitate stacking, and either a T-wall defining three compartments not in communication with each other or an X-wall defining four such compartments. The interior walls have an inverted “V”-shaped cross-section meeting at a rounded edge, the first leg and the second leg rotationally related by a highly acute angle to facilitate stacking. The method involves providing the bucket, placing cleaning liquid into the first clean compartment and fresh water into the one or two rinse compartment, dipping the mop in the cleaning liquid, washing the floor with the mop, and the repeated steps of rinsing the mop in the rinse compartments, draining the mop so that dirty water drains into the drain compartment, dipping the mop in the cleaning liquid, washing the floor with the mop.

### FIELD OF THE INVENTION

The field of this invention is mop buckets, and more particularly, mop buckets with multiple compartments.

### BACKGROUND OF THE INVENTION AND DISCUSSION OF THE PRIOR ART

When mopping floors, one dips the mop into a bucket containing fresh water and then mops. The mopping process causes a great deal of dirt to accumulate on the strings/braids of the mop. Typically, the mop is then drained by placing the strings of the mop into a squeezing drain mechanism that is attached to the top of the mop bucket, invoking the squeezing mechanism and then letting the dirty water drain back into the bucket where it mixes with the clean water. The process is then repeated. Prior to mopping a second time the worker dips the mop into the bucket to load the mop up with water but by the second or third time the water that is absorbed into the mop is mainly dirty water from the prior drainages of the mop bucket.

The result is that the worker using the mop bucket to clean floors is constantly emptying the mop bucket of its dirty water and re-filling it with new clean water. This wastes time, it waste effort, it wastes the cleaning fluid that had been mixed in with the clean water and it wastes a lot of water, which is a precious resource. In fact, for home use, people often have the habit of simply letting their water run in the sink while they mop. Thus there is a great need for a mop bucket and method therefore that alleviates these problems.

Furthermore, some mops have a self-twisting mechanism that allows draining of the mop without any device other than the mop itself. All that is needed is a place for the draining liquid to go. These mops have become popular. What is needed is a mop bucket that is versatile enough to function effectively with this kind of mop yet also be able to function effectively with the more traditional mop that makes use of a drain mechanism on the top of the mop bucket.

What is needed is a mop that accomplishes the above and overcomes these problems without generating significant additional cost in the manufacture of the mop bucket or in the complexity of the operation of the bucket.

In addition, the manufacturers, wholesalers, distributors and retailers of mop buckets have a significant need to temporarily store their merchandise. Mop bucket take up a great amount of space when being stored since the space in the cavity of the bucket normally also occupies space also. Consequently, what is needed is a mop bucket that can be stored efficiently and inexpensively.

The present invention accomplishes all of the above objectives as well as others.

### SUMMARY OF THE PRESENT INVENTION

A method and apparatus is presented involving an improved mop bucket that allows the worker to mop floors without having to constantly throw out the dirty water in the mop bucket every few times the mop is applied to the floor. The mop bucket allows the worker to rinse the mop one or more times prior to draining the mop. The rinsing occurs in a separate compartment that is not in contact with the clean water compartment housing the cleaning liquid. Therefore, when the worker dips the mop into the clean water compartment to absorb water and cleaning liquid, the mop does not also pick up dirty water.

The mop bucket of the present invention is also stackable. The mop bucket includes a bottom and an outer wall inclined so that the top portion of the outer wall is inclined more outward than the bottom of the outer wall to facilitate stacking. In one preferred embodiment in which the bucket has three compartments, the interior cavity of the bucket has in it a T-wall defining three compartments none of which are connected to each other or are in communication with each other. In a further preferred embodiment in which the bucket contains four compartments, the set of interior walls is shaped essentially like an “X”, called an X-wall, that defines the four separate compartments.

In either embodiment, the interior walls have an inverted “V”-shaped cross-section meeting at a rounded edge and the first leg and the second leg of the “V” although not parallel are rotationally related to each other by a highly acute angle to facilitate stacking. The method involves providing the bucket, placing cleaning liquid into a first clean compartment and fresh water into the one or two rinse compartment, dipping the mop in the cleaning liquid, washing the floor with the mop, and the repeatedly rinsing the mop in the rinse compartments, draining the mop into the drain compartment, dipping the mop in the cleaning liquid and washing the floor. In some embodiments, the worker first drains again prior to washing the floor to remove excess liquid.

The mop bucket is versatile so that it works with regular mops that are drain in a separate drain mechanism that sits on the mop bucket as well as with the recently popular self-twisting mop that can drain into a bucket without any other device or mechanism.

### IMPORTANT OBJECTS AND ADVANTAGES

The following important objects and advantages of the present invention are:

(1) to provide a mop bucket that allows the cleaning worker to mop a floor using clean water;

(2) to provide a mop bucket that allows a user to rinse off the mop before draining the mop;

(3) to provide a mop bucket that is specially designed to operate in tandem with a self-twisting mop;

(4) to provide a mop bucket that is designed to work with both a self-twisting mop and a mop that is drained by placing it into an external drain mechanism on the mop bucket;

(5) to provide a mop bucket that is stackable;

(6) to provide a versatile mop bucket;

(7) to provide a mop bucket that allows repeated rinsing of the mop;

(8) to provide a mop bucket that is easy to manufacture;

(9) to provide a mop bucket that is inexpensive to manufacture;

(10) to provide a mop bucket that greatly reduces the wasteful disposal of cleaning liquid;

(11) to provide a mop bucket that saves time in mopping the floor;

(12) to provide a mop bucket that eliminates the need to constantly throw out dirty water that has accumulated in the bucket prior to resuming mopping;

(13) to provide a mop bucket that saves the cost of purchasing new detergent thrown out with the dirty water;

(14) to provide a mop bucket that saves water because the worker no longer needs to empty and re-fill the bucket each time the water gets dirty;

(15) to provide a mop bucket having three or more compartments, and in some embodiments four or more compartment, that are separate from each other;

(16) to provide a method of mopping floors that utilizes an improved bucket;

(17) to provide such a method that that has the advantages (1) through (14);

(18) to provide a method of mopping floors that can be applied to a three-compartment mop bucket and a four compartment mop bucket; and

(19) to provide an improved mop bucket and a method therefore which overcomes the disadvantages of the prior art.

### BRIEF DESCRIPTION OF THE DRAWINGS

FIG. 1 is a perspective view of a three-compartment mop bucket of the present invention without the drain lid;

FIG. 2 is a cross-sectional view taken along line 2-2 of FIG. 1;

FIG. 3 is a top view of the three-compartment mop bucket of FIG. 1;

FIG. 4 is a cross-sectional view of the mop bucket of FIG. 1 taken along line 3-3 of FIG. 1;

FIG. 5 is a perspective view of a four compartment mop bucket of the present without the drain lid;

FIG. 6 is a cross-sectional view taken along line 6-6 of FIG. 5;

FIG. 7 is a top view of the mop bucket of FIG. 5;

FIG. 8 is a cross-sectional view of the mop bucket of FIG. 5 taken along line 8-8 of FIG. 5;

FIG. 9 is a perspective view of an alternative embodiment of the three-compartment mop bucket of the present invention without the drain lid;

FIG. 10 is a cross-sectional view taken along line 10-10 of FIG. 9;

FIG. 11 is a top view of the three-compartment mop bucket of FIG. 9;

FIG. 12 is a cross-sectional view taken along line 12-12 of FIG. 9;

FIG. 13 is a perspective view of an alternative embodiment of a four-compartment mop bucket of the present invention without the drain lid;

FIG. 14 is a cross-sectional view taken along line 14-14 of FIG. 13;

FIG. 15 is a top view of the four-compartment mop bucket of FIG. 13;

FIG. 16 is a cross-sectional view taken along line 16-16 of FIG. 13; and

FIG. 17 is a top view of the three-compartment mop bucket of the present invention with the drain lid in position for use.

### DETAILED DESCRIPTION OF THE PREFERRED EMBODIMENT

The apparatus of the present invention will now be illustrated by reference to the accompanying drawings. The mop bucket of the present invention has been assigned reference numeral 10. Other elements have been assigned the reference numerals referred to below.

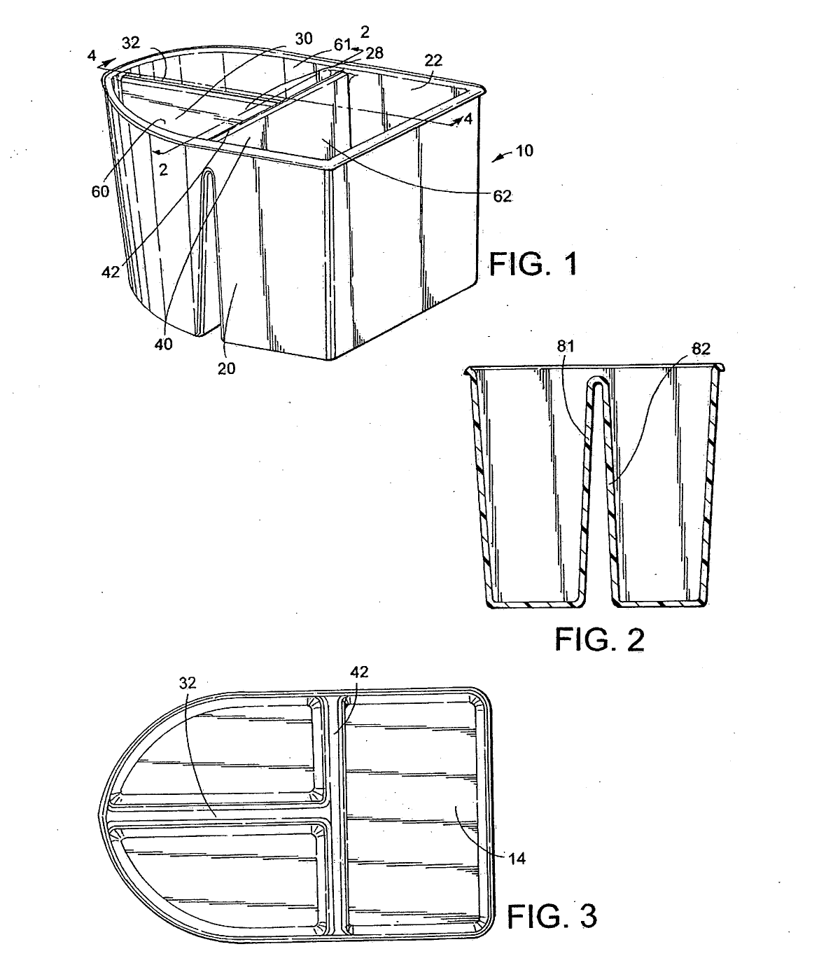

As can be seen from FIGS. 1-4 which depict one of the preferred embodiments of the present invention, the apparatus of the present invention is a mop bucket 10. As will be further appreciated from the detailed description below, this apparatus is a versatile and stackable three-compartment mop bucket 10. Bucket 10 comprises a bottom floor 14 and an outer wall 20 that defines a cavity above the bottom floor 14. The outer wall 20 is inclined so that the cavity of the interior of the bucket 10 is actually wider at a top of the bucket than at the bottom floor of the bucket 10. This is to facilitate stacking of a plurality of such mop buckets, as will be further detailed below.

This embodiment has three compartments and is shaped like a torpedo. The phrase “torpedo-shaped” as used herein merely refers generally to the fact that the top perimeter of the outer wall 20 of bucket 10 is arcuate at one end, as best appreciated from FIG. 1 and is substantially flat at the pother end. The corners of bucket 10 distal from the arcuate end need not be sharp corners but rather may be rounded. The exact shape of the top perimeter of the bucket is not an essential element needed to accomplish the purposes of the apparatus and method of the present invention and is merely presented to illustrate one example of the present invention.

As can be seen from FIGS. 1-4, in the interior cavity of the bucket 10 there is located a T-wall 28 composed of two ports. The T-wall 28 includes a first vertical wall portion 30 and a second vertical wall portion 40. First vertical wall portion 30 and second vertical wall portion 40 thus form a “T” when they intersect. Although FIGS. 1 and 3 show the interesting first vertical wall portion 30 as meeting second vertical wall portion 40 at a midpoint of second vertical wall portion 40, it is certainly contemplated by the present invention that they can meet at other points. However, so that a sufficient amount of liquid, as explained further below, can be maintained in the respective compartments defined by these walls, and to simplify stackability of the bucket 10, it may be preferable if the first vertical wall portion 30 meets at the midpoint of second vertical wall portion 40.

The T-wall 28 defines three compartments. The first compartment is conveniently called the first clean compartment 60 and it is for storing a cleaning liquid, which typically is water plus a detergent. The second compartment is called rinse compartment 61 and it is for storing clean water. When the mop is dirty from having been used to mop the floor two or three or more times, then prior to draining the mop, the worker first rinses the dirt off the mop by dipping it into the clean water in rinse compartment 61. Only then does the worker drain the mop in the third compartment 62 which is called the rinse and drain compartment.

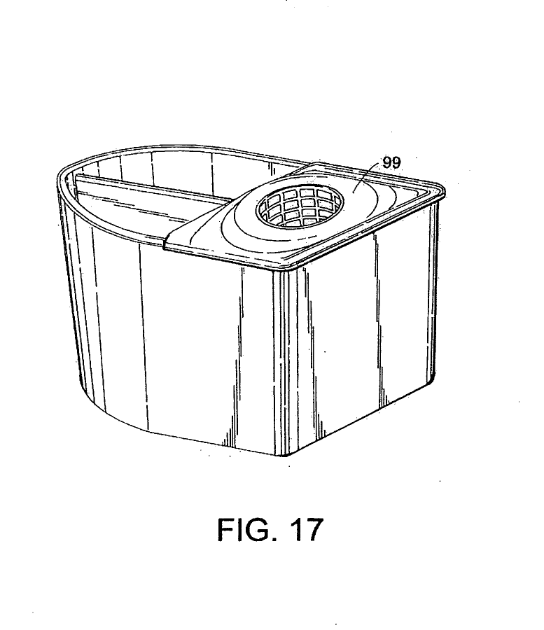

Depending upon whether the mop is a self-twisting mop or a regular mop, the rinse and drain compartment 62 can be used to rinse or to drain the mop as follows. If the mop is a regular mop, which requires a drain mechanism to squeeze or drain the dirty water out of the mop's strings, then the third compartment 62 is a drain compartment and it is not filled with water. Rather it simply receives the dirty water that drains from the draining process when the mop is placed in the drain mechanism 99 located on the top of the drain compartment 62, as best seen from FIG. 17. The drain mechanism 99 typically looks like a lid with an aperture to stick the mop into.

There is, however, a new kind of mop that is called a “self-twisting mop” It is made by a company called Vileda and sold by O-Cedar under the name Pro Wring®. It is called this because it can be drained without placing the mop on a drain mechanism located on the mop bucket but rather it can be twisted on its own. In this case, the lid/drain mechanism is removed from covering the drain and rinse compartment 62 and this compartment is filled up with fresh water. Rinse and drain compartment 62 then operates as a second place to dip the mop in prior to draining it. After rinsing the mop in the rinse compartment 61, rinse the mop a second time by dipping it into the clean water in the rinse and drain compartment 62. Then drain it by self-twisting it over the rinse and drain compartment 62 without any lid on compartment 62. The dirty mop from the draining just falls into rinse and drain compartment 62.

Although the drawing may have depicted the rinse and drain compartment 62 to be somewhat larger than the first clean water compartment 60 and the rinse compartment 61, these two compartments, 60, 61 may be of equal size whereas rinse and drain compartment 62 may be smaller because the most important compartments in terms of the availability of quantities of water are the first clean water compartment 60 and the rinse compartment 61. For example, in one preferred embodiment, rinse and drain compartment 62 occupies 30 percent of the volume of the mop bucket's 10 capacity and the remaining 60 percent is divided equally between the first clean water compartment 60 and the rinse compartment 61.

In a preferred embodiment, rinse and drain compartment 62 is bounded by the outer wall 20, the floor 14 and the second vertical wall portion 40 of the T-wall 28. It is noted from FIGS. 1-4 that neither the first clean compartment, the rinse compartment nor the rinse and drain compartment are in communication with each other. This is a basic requirement of the present invention since the clean water in the rinse compartment 61 should not mix with the dirty water in the rinse and drain compartment 62, nor should either of these mix with the cleaning liquid in the first clean water compartment 60.

In a preferred embodiment, a top 32 of the first vertical wall portion 30 and a top 42 of the second vertical wall portion 40 are as high or almost as high as the top of an inside facade 22 of the outer wall 20. When it is stated herein that top 32 of the first vertical wall portion 30 and the top 42 of the second vertical wall portion 40 are substantially as high as a top of an inside facade 22 of the outer wall 20, this means they are at least 80 to 90 percent as high. In order to maximize the capacity of the various compartments, the set of interior walls, which in this embodiment is T-wall 28 should not be too low. For example, if T-wall were only half as high as facade 22 of outer wall 20, this would be a poor alternative embodiment. Furthermore, first vertical wall portion 30 should be as high as the second vertical wall portion 40. However, it is certainly contemplated by the present invention that there could be differences in height between first vertical wall portion 30 and second vertical wall portion 40 without negating the basic purposes and spirit of the present invention.

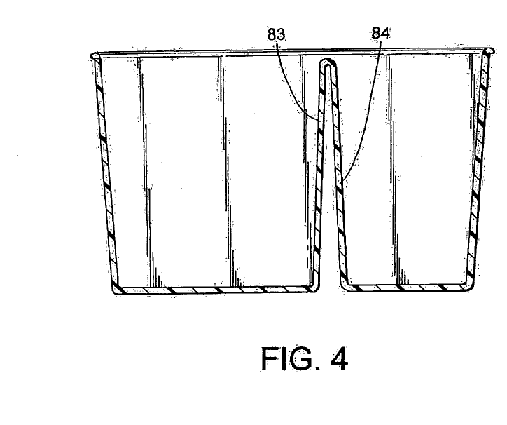

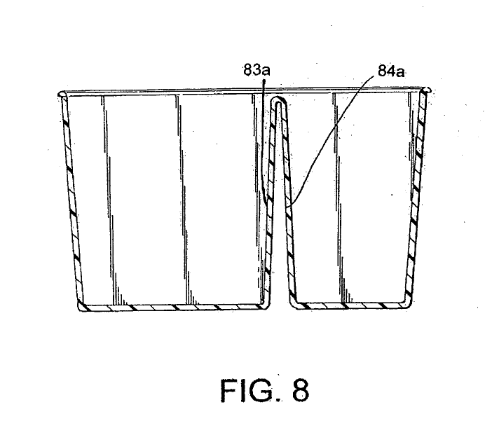

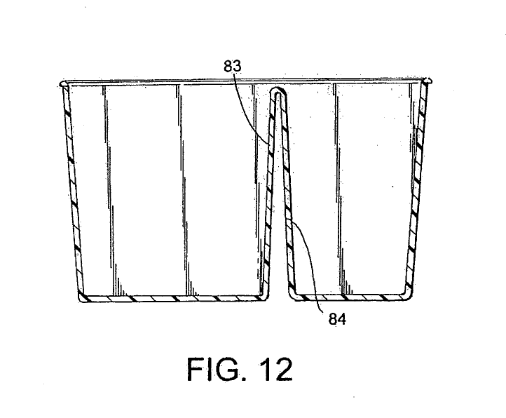

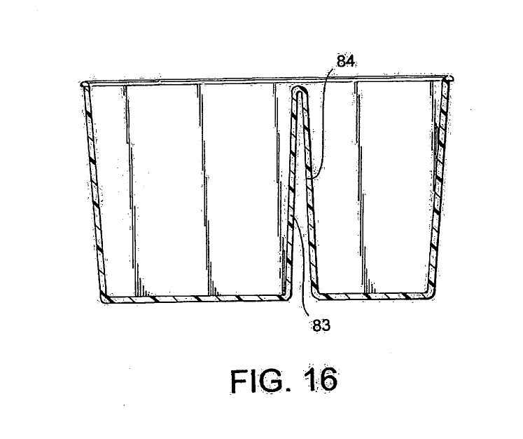

First vertical wall portion 30 and the second vertical wall portion 40 each have an inverted “V”-shaped cross-section, as best seen in FIGS. 2 and 4 (and in FIGS. 6, 8, 10, 12, 14, 16 of the other embodiments) comprising a first leg 81, 83 of a “V” and a second leg 82, 84 of the “V”. In the case of first vertical wall portion 30, first leg 81 and second leg 82 meet not at a pointed edge but in a preferred embodiment meet at a rounded edge. In the case of second vertical wall portion 40, first leg 83 and second leg 84 meet at a rounded edge also. This is seen from FIGS. 2, 4, etc. With respect to both first vertical wall portion 30 and second vertical wall portion 40, the first leg 81 or 83 and the second leg 82 or 84 are rotationally related to each other by a highly acute angle that is preferably approximately 10 to approximately 15 rotational degrees and in most preferred embodiments less than approximately 20 to 30 rotational degrees. This inverted “V” shaped cross-section is to facilitate stacking of a plurality of mop buckets identical to the mop bucket of the present invention. The angle between first leg 81 and second leg 82 of first vertical wall portion 30 and the angle between first leg 83 and second leg 84 of second vertical wall portion 40 should be large enough to allow insertion of the first and second vertical wall portions 30, 40 of a second mop bucket 10 right on top of the first mop bucket 10 when stacking a plurality of such identical mop buckets during storage and delivery. This angle should not be so large that liquid from one compartment can splash into a second or third compartment.

Wheels are not shown in the drawings. Generally speaking, the consumers use the torpedo-shaped embodiment whereas the rectangular version is more likely to be used commercially. For an industrial sized mop bucket, although not shown in the drawings, below the floor of the bucket 10 can be two or more wheels attached to the bottom facade of the floor 14 that make it easy to move the bucket 10 around.

It should be understood that the division of the interior of the bucket by T-wall 28 is only one way of dividing the bucket into three compartments. For example, two parallel walls instead of a single T-wall 28 can be used. However, that might make the bucket 10 be too long and less convenient for placement into all places that it has to be placed in. Furthermore, in order to maintain a low cost of manufacturing and ease of use, this way is preferred. The T-wall also serves to keep the mop bucket as similar to existing buckets in their overall shape and appearance as possible. Thus the three-compartment mop bucket of FIGS. 1-4 can be used with the existing drain lid mechanisms that fit over the edge of existing mop buckets.

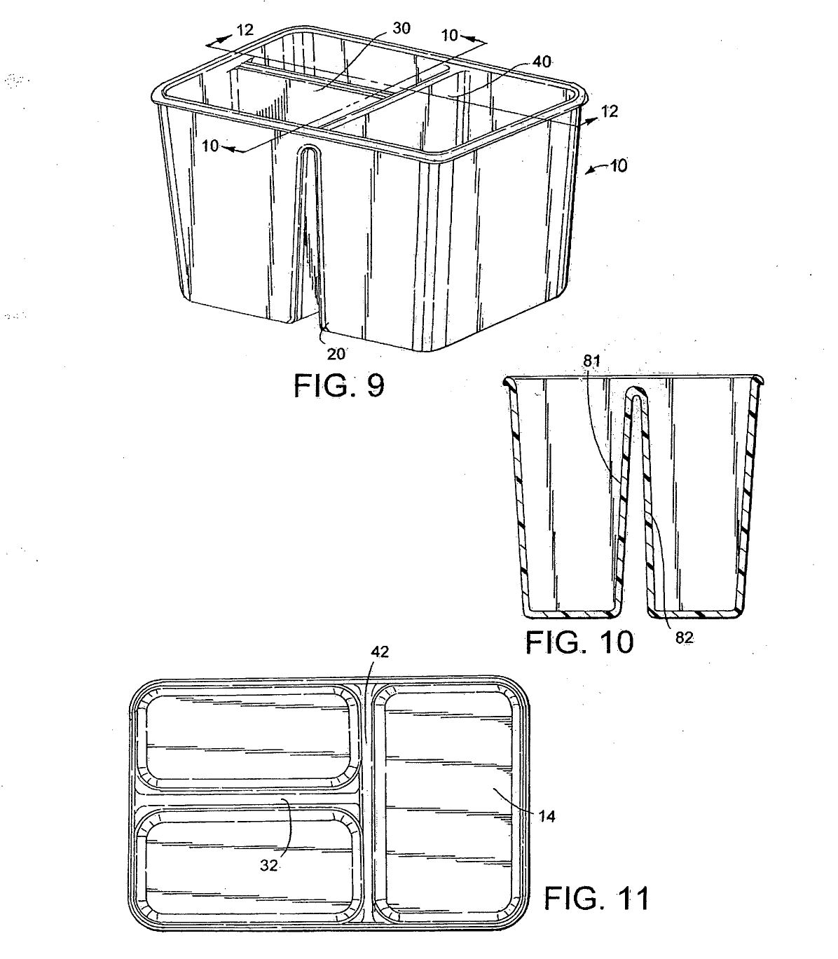

An alternative embodiment is shown by FIGS. 9-12. In this alternative embodiment, the mop bucket 10 is identical to the mop bucket shown in FIGS. 1-4 except that the shape of the bucket 10 as defined by the shape of the top 22 of outer wall 20 is substantially rectangular with rounded corners, rather than torpedo-shaped. This shape is the basic outer shape of certain kinds of popular existing mop buckets. Thus, the mop bucket 10 of FIGS. 9-12 can be used with existing drain lid mechanism that fit over a portion of the top of the bucket 10.

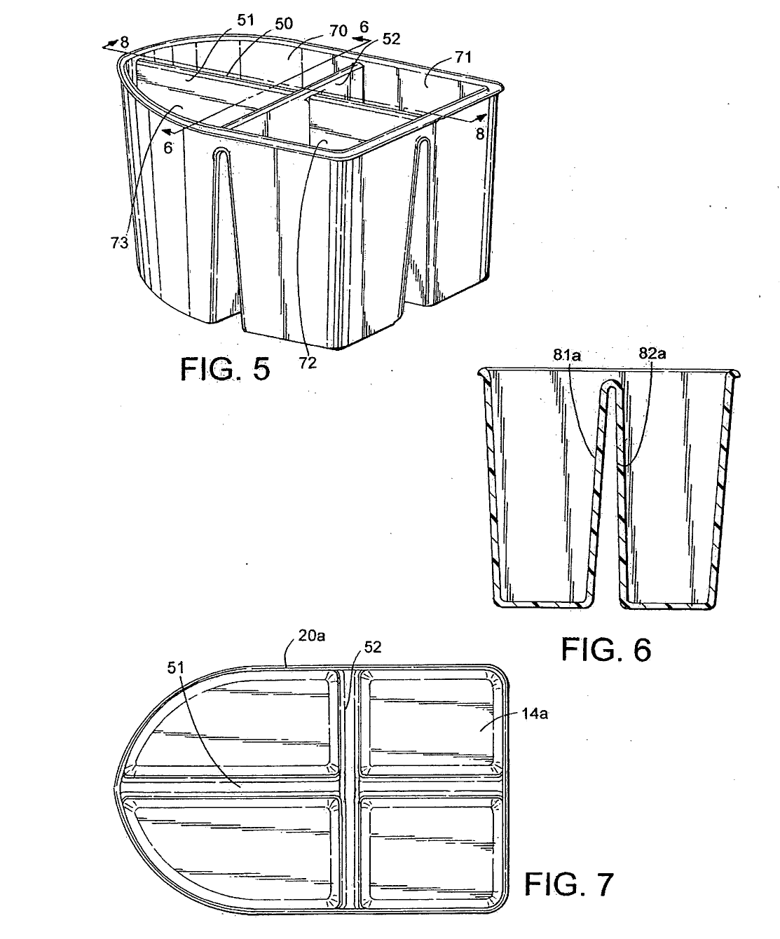

In the preferred embodiment of FIGS. 5-9, there are four compartments rather than three. The shape of bucket 10 shown in FIGS. 5-9 is like a torpedo, similar to the shape of bucket 10 shown in FIGS. 1-4. Instead of a T-wall 28, however, there is a set of interior walls that divide the cavity of the bucket 10 into four compartments. In a preferred embodiment, the set of interior walls in the shape of an “X” where the two lines of the “X” meet at right angles. Although this shape is not required, it is the shape shown in the FIGS. 5-9. As seen from these figures, X-wall 50 comprising a first vertical wall portion 51 and a second vertical wall portion 52, the first vertical wall portion and the second vertical wall portion intersecting at approximately a normal or right angle. The X-wall 50 defines first compartment 70 for storing a cleaning liquid, a second compartment 71 for storing water used for rinsing a dirty mop prior to draining the mop, the third compartment 72 for storing water used for a second rinse of the mop before draining the mop and a fourth compartment 73 for receiving dirty water drained from the dirty mop. A drain cover and mechanism generally similar to that shown in FIG. 17 but smaller would cover the fourth compartment 73.

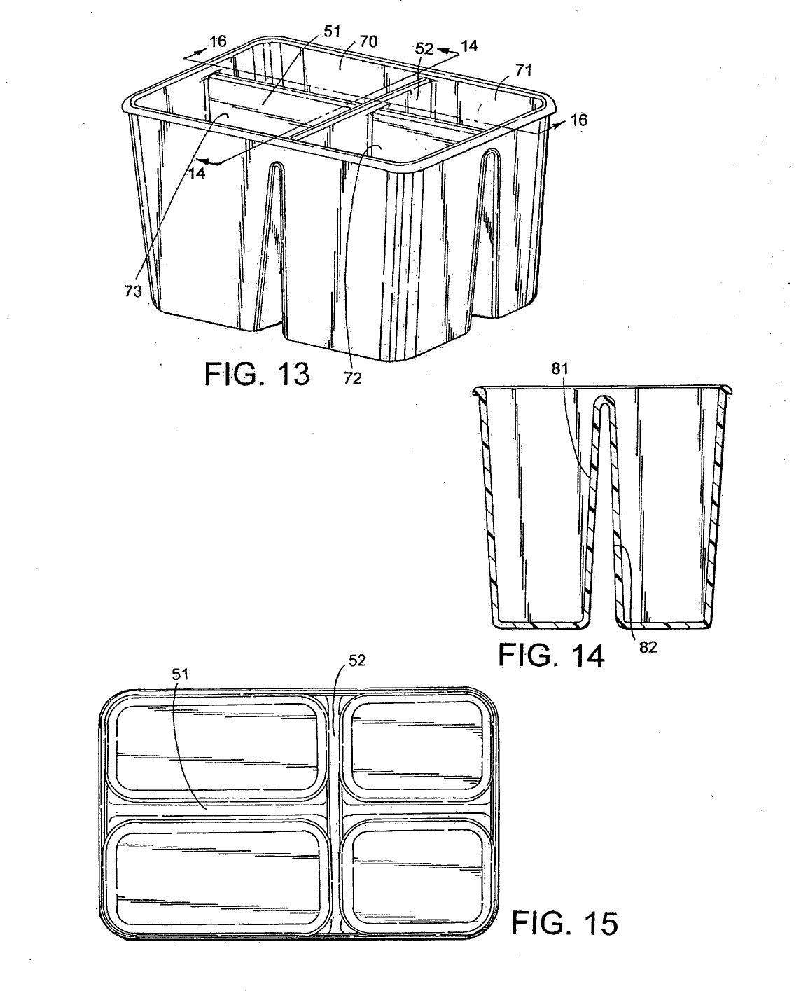

In an alternative embodiment shown in FIGS. 13-16 for the four compartment embodiment of bucket 10, the mop bucket 10 is identical to the mop bucket shown in FIGS. 5-9 except that the shape of the bucket 10 as defined by the shape of the top 22 of outer wall 20 is substantially rectangular with rounded corners, rather than torpedo-shaped. This shape is the basic outer shape of certain kinds of popular existing mop buckets. Thus, the mop bucket 10 of FIGS. 13-16 can be used with existing drain lid mechanism that fit over a portion of the top of the bucket 10.

It should be noted that with respect to the embodiment shown in FIGS. 13-16, although FIG. 15 shows the compartments 71, 72 as small, in a preferred embodiment the four compartments 70, 71, 72, 73 are of equal size.

The method of the present invention involves providing any of the two three-compartment embodiments of the mop bucket 20 of the present invention shown in FIGS. 1-4 and FIGS. 9-12, followed by the steps of placing cleaning liquid into the first clean compartment and fresh water into the rinse compartment, dipping the mop in the cleaning liquid, washing the floor with the mop, rinsing the mop in the rinse compartment, draining the mop so that dirty water drains into the rinse and drain compartment, dipping the mop in the cleaning liquid, washing the floor with the mop, and then repeating the steps of rinsing the mop in the rinse compartment, draining the mop so that dirty water drains into the rinse and drain compartment, dipping the mop in the cleaning liquid, and washing the floor with the mop as many times as is necessary.

In a preferred embodiment, prior to washing the floor with the mop, there is an additional step of draining the mop so that excessive cleaning liquid drains into the rinse and drain compartment because one does not want to mop with too much liquid in the mop. This additional step is repeated each time before mopping the floor.

In certain embodiments, the present invention also contemplates a mop bucket containing five, or more compartments with a variety of possible interior walls to accomplish this and it is not intended to limit the method and apparatus of the present invention to mop buckets that only three or four compartments.

With the present invention, it may be unnecessary to empty and replace the water in the mop bucket during the entire mopping job, depending on how big the job is. Nevertheless, in certain alternative embodiments given the fact that it might conceivably be necessary to remove the dirty water from the rinse and drain compartment 62 and rinse compartment 61 without removing the water and cleaning liquid from the first clean compartment 60, it is at least contemplated by the present invention that the rinse and drain compartment 62 and rinse compartment 61 can have a drain hole and plug in the drain hole for draining out the dirty water directly without having to lift the bucket 10. This could cause leakage, however, so this is considered merely an alternative embodiment that is not preferable.

It is to be understood that while the method and apparatus of the present invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A versatile and stackable three-compartment mop bucket, comprising:
a bottom floor,
an outer wall defining a cavity above the bottom floor, the outer wall inclined so that the cavity is wider at a top of the bucket than at the bottom floor of the bucket to facilitate stacking of a plurality of mop buckets,
a T-wall through the cavity, the T-wall including a first vertical wall portion and a second vertical wall portion, the first vertical wall portion and the second vertical wall portion forming a “T”, the T-wall defining a first clean compartment for storing a cleaning liquid, a rinse compartment for storing water used for rinsing a dirty mop prior to draining the mop and a rinse and drain compartment for receiving water drained from the dirty mop and/or for storing water to be used for a second rinse, the rinse and drain compartment bounded by the outer wall, the floor and the second vertical wall portion of the T-wall, wherein neither the first clean compartment, the rinse compartment nor the rinse and drain compartment are in communication with each other, and wherein a top of the first vertical wall portion and a top of the second vertical wall portion are substantially as high as a top of an inside facade of the outer wall,
the first vertical wall portion and the second vertical wall portion each having an inverted “V”-shaped cross-section comprising a first leg of a “V” and a second leg of the “V”, the first and second legs meeting at a rounded edge, the first leg and the second leg rotationally related by a highly acute angle to facilitate stacking of the plurality of mop buckets.

2. The mop bucket of claim 1, wherein the top of the outer wall is rectangular.

3. The mop bucket of claim 1, wherein the top of the outer wall is torpedo-shaped.

4. The mop bucket of claim 1, wherein the rinse and drain compartment has a drain lid covering the rinse and drain compartment, the drain lid including a drain mechanism.

5. The mop bucket of claim 4, wherein the rinse and drain compartment is for receiving water drained from the dirty mop.

6. A versatile and stackable three-compartment mop bucket, comprising:
a bottom floor,
an outer wall defining a cavity above the bottom floor, the outer wall inclined so that the cavity is wider at a top of the bucket than at the bottom floor of the bucket to facilitate stacking of a plurality of mop buckets,
a set of interior walls including a first vertical wall portion and a second vertical wall portion, the set of interior walls defining a first clean compartment for storing a cleaning liquid, a rinse compartment for storing water used for rinsing a dirty mop prior to draining the mop and a rinse and drain compartment for receiving water drained from the dirty mop and/or for storing water to be used for a second rinse, the rinse and drain compartment bounded by the outer wall, the floor and the second vertical wall portion of the set of interior walls, wherein neither the first clean compartment, the rinse compartment nor the rinse and drain compartment are in communication with each other,
the first vertical wall portion and the second vertical wall portion each having an inverted “V”-shaped cross-section comprising a first leg of a “V” and a second leg of the “V”, the first and second legs meeting at a rounded edge, the first leg and the second leg rotationally related by a highly acute angle to facilitate stacking of the plurality of mop buckets.

7. The mop bucket of claim 6, wherein a top of the outer wall is rectangular with rounded corners.

8. The mop bucket of claim 6, wherein a top of the outer wall is torpedo-shaped.

9. The mop bucket of claim 6, wherein the rinse and drain compartment has a drain lid covering the rinse and drain compartment, the drain lid including a drain mechanism.

10. The mop bucket of claim 9, wherein the rinse and drain compartment is for receiving water drained from the dirty mop.

11. A versatile and stackable four-compartment mop bucket, comprising:
a bottom floor,
an outer wall defining a cavity above the bottom floor, the outer wall inclined so that the cavity is wider at a top of the bucket than at the bottom floor of the bucket to facilitate stacking of a plurality of mop buckets,
an X-wall through the cavity comprising a first vertical wall portion and a second vertical wall portion, the first vertical wall portion and the second vertical wall portion intersecting at approximately a normal, the X-wall defining a first compartment for storing a cleaning liquid, a second compartment for storing water used for rinsing a dirty mop prior to draining the mop, a third compartment for storing water used for a second rinse of the mop before draining the mop and a fourth compartment for receiving water drained from the dirty mop,
the first vertical wall portion and the second vertical wall portion each having an inverted “V”-shaped cross-section comprising a first leg of a “V” and a second leg of the “V”, the first and second legs meeting at a rounded edge, the first leg and the second leg rotationally related by a highly acute angle to facilitate stacking of the plurality of mop buckets.

12. The mop bucket of claim 11, wherein a top of the outer wall is rectangular with rounded corners.

13. The mop bucket of claim 11, wherein a top of the outer wall is torpedo-shaped.

14. The mop bucket of claim 11, wherein the fourth compartment has a drain lid covering the fourth compartment, the drain lid including a drain mechanism.

15. A method of mopping floors, comprising the steps of:
(a) providing a three-compartment mop bucket that includes:
a bottom floor,
an outer wall defining a cavity above the bottom floor, the outer wall inclined so that the cavity is wider at a top of the bucket than at the bottom floor of the bucket to facilitate stacking of a plurality of mop buckets,
a T-wall through the cavity, the T-wall including a first vertical wall portion and a second vertical wall portion, the first vertical wall portion and the second vertical wall portion forming a “T”, the T-wall defining a first clean compartment for storing a cleaning liquid, a rinse compartment for storing water used for rinsing a dirty mop prior to draining the mop and a rinse and drain compartment for receiving water drained from the dirty mop and/or for storing water to be used for a second rinse, the rinse and drain compartment bounded by the outer wall, the floor and the second vertical wall portion of the T-wall, wherein neither the first clean compartment, the rinse compartment nor the rinse and drain compartment are in communication with each other, and wherein a top of the first vertical wall portion and a top of the second vertical wall portion are substantially as high as a top of an inside facade of the outer wall,
the first vertical wall portion and the second vertical wall portion each having an inverted “V”-shaped cross-section comprising a first leg of a “V” and a second leg of the “V”, the first and second legs meeting at a rounded edge, the first leg and the second leg rotationally related by a highly acute angle to facilitate stacking of the plurality of mop buckets.
(b) placing cleaning liquid into the first clean compartment and fresh water into the rinse compartment,
(c) dipping the mop in the cleaning liquid,
(d) washing the floor with the mop,
(e) rinsing the mop in the rinse compartment,
(f) draining the mop so that dirty water drains into the rinse and drain compartment
(g) dipping the mop in the cleaning liquid,
(h) washing the floor with the mop,
(i) repeating steps (e), (f), (g) and (h) as many times as is necessary

16. The method of claim 15, wherein prior to step (h) there is an additional step of draining the mop so that excessive cleaning liquid drains into the rinse and drain compartment and wherein step (i) involves repeating steps (e), (f), (g) and (h) with the additional step inserted prior to step (h).

17. A method of mopping floors, comprising the steps of:
(a) providing a four-compartment mop bucket that includes:
a bottom floor,
an outer wall defining a cavity above the bottom floor, the outer wall inclined so that the cavity is wider at a top of the bucket than at the bottom floor of the bucket to facilitate stacking of a plurality of mop buckets,
an X-wall through the cavity comprising a first vertical wall portion and a second vertical wall portion, the first vertical wall portion and the second vertical wall portion intersecting at approximately a normal, the X-wall defining a first compartment for storing a cleaning liquid, a second compartment for storing water used for rinsing a dirty mop prior to draining the mop, a third compartment for storing water used for a second rinse of the mop before draining the mop and a fourth compartment for receiving water drained from the dirty mop,
the first vertical wall portion and the second vertical wall portion each having an inverted “V”-shaped cross-section comprising a first leg of a “V” and a second leg of the “V”, the first and second legs meeting at a rounded edge, the first leg and the second leg rotationally related by a highly acute angle to facilitate stacking of the plurality of mop buckets,
(b) placing cleaning liquid into the first clean compartment and fresh water into the second and third compartments,
(c) dipping the mop in the cleaning liquid,
(d) washing the floor with the mop,
(e) rinsing the mop in the second compartment and in the third compartments,
(f) draining the mop so that dirty water drains into the fourth compartment,
(g) dipping the mop in the cleaning liquid,
(h) washing the floor with the mop,
(i) repeating steps (e), (f), (g) and (h) as many times as is necessary

18. The method of claim 17, wherein prior to step (h) there is an additional step of draining the mop so that excessive cleaning liquid drains into the rinse and drain compartment and wherein step (i) involves repeating steps (e), (f), (g) and (h) with the additional step inserted prior to step (h).

19. A method of mopping floors, comprising the steps of:
(a) providing a mop bucket having three or more compartments that includes:
a bottom floor,
an outer wall defining a cavity above the bottom floor, the outer wall inclined so that the cavity is wider at a top of the bucket than at the bottom floor of the bucket to facilitate stacking of a plurality of mop buckets,
a set of interior walls through the cavity, the set of interior walls including a first vertical wall portion and a second vertical wall portion, the first vertical wall portion and the second vertical wall portion intersecting, the set of interior walls defining a first clean compartment for storing a cleaning liquid, a rinse compartment for storing water used for rinsing a dirty mop prior to draining the mop and a rinse and drain compartment for receiving water drained from the dirty mop and/or for storing water to be used for a second rinse, wherein neither the first clean compartment, the rinse compartment nor the rinse and drain compartment are in communication with each other, and wherein a top of the first vertical wall portion and a top of the second vertical wall portion are substantially as high as a top of an inside facade of the outer wall,
the first vertical wall portion and the second vertical wall portion each having an inverted “V”-shaped cross-section comprising a first leg of a “V” and a second leg of the “V”, the first and second legs meeting at a rounded edge, the first leg and the second leg rotationally related by a highly acute angle to facilitate stacking of the plurality of mop buckets.
(b) placing cleaning liquid into the first clean compartment and fresh water into the rinse compartment,
(c) dipping the mop in the cleaning liquid,
(d) washing the floor with the mop,
(e) rinsing the mop in the rinse compartment,
(f) draining the mop so that dirty water drains into the rinse and drain compartment
(g) dipping the mop in the cleaning liquid,
(h) washing the floor with the mop,
(i) repeating steps (e), (f), (g) and (h) as many times as is necessary

20. The method of claim 19, wherein prior to step (h) there is an additional step of draining the mop so that excessive cleaning liquid drains into the rinse and drain compartment and wherein step (i) involves repeating steps (e), (f), (g) and (h) with the additional step inserted prior to step (h).
